(19) United States
(12) Patent Application Publication
(10) Pub. No.: US 2014/0115713 A1
(43) Pub. Date: Apr. 24, 2014

(54) PROVIDING ELECTRONIC SIGNATURE SERVICES TO THIRD PARTY APPLICATIONS BASED ON API CALLS

(71) Applicant: Paul Picazo, Mountain View, CA (US)

(72) Inventor: Paul Picazo, Mountain View, CA (US)

(73) Assignee: ADOBE SYSTEMS INCORPORATED, SAN JOSE, CA (US)

(21) Appl. No.: 13/658,711

(22) Filed: Oct. 23, 2012

(51) Int. Cl. G06F 21/64

(52) U.S. Cl. CPC G06F 21/64
USPC 726/26

(57) ABSTRACT

Systems and methods for providing an electronic signature service to a third party application, such as providing the certain stages or aspects of the service, are disclosed. In some examples, an electronic signature service receives a request for the service in the form of an API call from a third party application (e.g. a document editing application), and provides the service in response to the API call. In some examples, a third party application receives input from a user regarding a requested service, generates an API call based on the received input, and transmits the API call to the service in order to request the service.

### TECHNICAL FIELD

The present disclosure generally relates to electronic signature services. More specifically, the present disclosure relates to methods, systems and computer program products for providing electronic signature services to third party applications based on application programming interface (API) calls.

### BACKGROUND

Obtaining a person's hand-written signature on a document can be a time consuming task. Fortunately, electronic signatures have become widely accepted. Although there are many different legal definitions for what exactly constitutes an electronic signature, generally an electronic signature is a digital mark (e.g., a set of characters or an image representative of a name) generated with some electronic means (e.g., with a computer or other electronic device and that is attached to, or otherwise associated with an electronic or digital document, and intended to serve the same purpose as a hand-written signature. Various electronic signature services have made the process of obtaining an electronic signature far more efficient than the time consuming task of obtaining a hand-written signature. Unfortunately, many conventional electronic signature services do not support anything more than the most basic of workflows, and thus, do not provide the customization and flexibility that is frequently needed to control who can access and view a document, or a portion of a document, and control when that access and visibility is permitted.

### DESCRIPTION OF THE DRAWINGS

Some embodiments of the technology are illustrated by way of example and not limitation in the figures of the accompanying drawings, in which:

FIG. 1 is a block diagram illustrating an example of a network environment including a server operating an electronic signature service capable of providing electronic signature services to third party applications. consistent with some embodiments.

FIG. 2 is a block diagram illustrating an example of how an electronic signature service, consistent with some embodiments of the technology, provides one or more aspects of the service to a third party application.

FIG. 3 is a flow diagram illustrating an example method for providing a requested stage of an electronic signature service to a third party application, consistent with some embodiments.

FIG. 4 is a flow diagram illustrating an example method for a third party application to request a specific aspect of an electronic signature service using an API call, consistent with some embodiments.

FIG. 5 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for providing electronic signature services to third party applications based on application programming interface (API) calls. In some examples, an electronic signature service receives a request to provide the service in the form of an API call from a third party application (e.g. a document management application), and provides the service in response to and/or based on the API call. In some examples, a third party application receives input from a user regarding a request to utilize the service, generates an API call based on the received input, and transmits the API call to the service in order to request the service.

For example, a user is creating a rental contract for a prospective tenant via a document editing application running on his tablet computer, and wishes to add a signature field to the contract that will enable the tenant to electronically sign the contract once received. The user, via the document editing application, engages with a web-based electronic signature service, which provides the document editing application with access to a services workflow at a stage that facilitates the entry of signature fields. To do so, the document editing application calls an API of the service with information identifying the application and information requesting use of the e-signature portion of the service. Once called, the electronic signature service provides information (e.g. a URL to a webpage associated with the e-signature portion of the service) to the application that enables facilitates adding the signature field to the contract.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

For purposes of the present disclosure, the terms “document author”, “document originator” and “signature requester” are used synonymously to refer to a person who is utilizing an electronic signature service to request that one or more persons electronically sign an instance of a document package. As such, the document author or document originator may or may not be the actual author of a particular written work product. Additionally, the term “document package” is used herein to refer to the document that is generated by the electronic signature service. For example, from the perspective of the electronic signature service, a document package may in fact be comprised of several original documents or source documents, with each original or source document being a file that has been uploaded to a server providing the electronic signature service. Accordingly, the electronic signature service takes as input one or more original or source documents (e.g., individual source files) that are uploaded to the server providing the electronic signature service, performs various operations on the input files, and then manages the one or more files as a single instance of a document, referred to herein as an instance of a document package, for purposes of any signature operations that are to be performed with the one or more uploaded files. As such, the term “document package” is used to refer to a document (or group of documents) that have been uploaded to the server of the electronic signature service, and managed as a single instance of a document by the electronic signature service. Therefore, from the perspective of the electronic signature service, an instance of a document package may in tact be several input files (e.g., source documents), along with any metadata that is generated and associated with any one of the input files that makes up the document package.

Other advantages and aspects of the inventive subject matter will be readily apparent from the description of the figures that follows.

### Suitable System

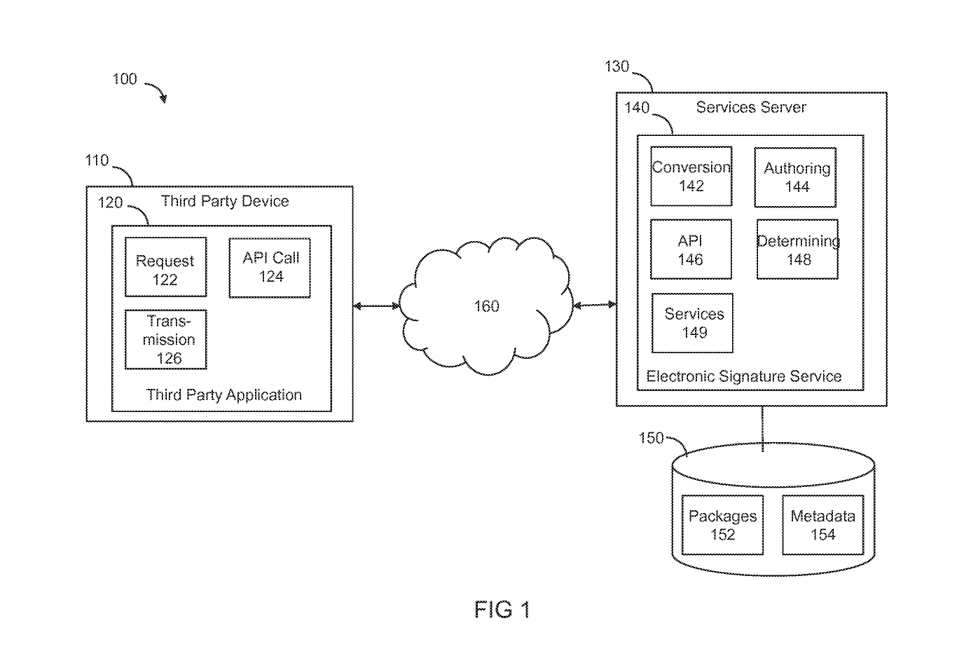

FIG. 1 is a block diagram illustrating an example of a network environment 100 including a server operating an electronic signature service 140 capable of providing electronic signature services to third party applications, consistent with some embodiments. A third party device 110 supporting a third party application 120, such as a tablet or laptop computer supporting and running document rendering application may communicate with an electronic signature service 140 located at a server 130 over a network 160, such as the Internet.

Via the third party application 120, which may be executing at the third party device 110, a signature requester may upload one or more documents to the electronic signature service 130, specify the email addresses (or other messaging addresses) of one or more persons who are to sign the documents, and request that the documents be signed. Upon making the request, an email or other electronic message (e.g., SMS, or text message, instant message, and so on) is communicated from the server 130 associated with the electronic signature service 140 to a computing device of the document recipients whose email address (or other messaging address) has been provided. The message typically will include a link or otherwise provide an address (e.g., Uniform Resource Locator (URL)) associated with a web page hosted by the electronic signature service 130 at which an instance of the document package can be accessed.

The third party application 120 may also communicate with the electronic signature service 140 when the signature requester is creating, generating, editing, updating, and/or otherwise managing the documents, in order to receive interactive services from the electronic signature service that assist the signature requester in creating and/or editing the document, among other things. Examples of such interactive services that may be provided by the electronic signature service 140 include authoring services, prefill services, e-signature services, postfill services, finalization services, transmission services, and so on.

As illustrated in FIG. 1, the electronic signature service 140 includes a variety of functional modules. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein.

In some example embodiments, the electronic signature service 140 includes a conversion module 142. In general, the conversion module 142 may receive one or more original input documents (e.g., files), over the network 150. For instance, the signature requester may upload the one or more input files to the electronic signature service 140. Once received, the conversion module 142 is triggered to perform a conversion operation on the one or more input files. In particular the conversion module 142 will process the individual input files to generate a single document package in a portable document format, such as a PDF file. Of course, other document or file formats may be used. In addition, the conversion module 142 may generate metadata that is stored in the database in association with the document package. For example, as illustrated in FIG. 1, a database 150 stores document packages 152 (e.g., processed input files), and associated metadata 154

In some example embodiments, the electronic signature service 140 includes an authoring module 144. The authoring module 144 operates in conjunction with a user interface module (e.g., a web server module, not shown), to enable the signature requester to provide a variety of information (e.g., configuration parameters or settings) used with the signature request. For example, the authoring module 144 provides a graphical user interface with which the signature requester may specify the location (e.g., page and position on page) of signature fields, date fields, or fields where a person is to provide his or her initials, and any other similar type of field that may be used to receive input data. This may be achieved, for example, by simply dragging and dropping various user interface elements, and then manipulating the size and position of those elements. Additionally, the authoring module may provide the various interactive services described herein.

In addition to allowing the signature requester to add, delete, or otherwise edit fields within the document package, the authoring module 144 facilitates the establishment of document visibility setting for each person who has been specified to receive and/or sign a copy of a document package. For example, using a graphical user interface associated with the authoring module 144, the document author or signature requester my specify that certain document recipients are to have visibility or access rights that allow that person to view only some portions (e.g., source documents, document sections, or pages) of the document package.

In some example embodiments, document visibility rights can be established for each person who is to receive and/or sign the document, and can be specified on a per-page, per-document section, or per-source document basis. Additionally, with some embodiments, document visibility rights may be defined for each person based on membership in a group. For example, in some embodiments, the electronic signature service 140 will allow users to generate accounts, and then add persons (as users) to the account. Accordingly, a signature requester may specify that certain portions of a document package are to be visible to only those persons who are members of or otherwise associated with, a particular account, group or sub-group. Similarly, in some embodiments, visibility rights may be defined based on membership with a domain, such that various portions of a document may be visible or not visible to persons based on the domain name portion of their email address, or other messaging address.

In some example embodiments, the authoring module 144 may not be required or provided, and the conversion module 142 may identify text-tags that are embedded in the source documents, and automatically convert those tags into fields. As such, the authoring step may be bypassed. In such examples, the conversion module 142 will output a document package with corresponding metadata including any fields that have been automatically generated as the result of processing embedded text-tags in the source documents.

As illustrated in FIG. 1, the electronic signature service 140 may also include modules that facilitate the provision of interactive services to the third party application 120, including an API module 146, a determining module 148, and a services module 149, among other things.

In some example embodiments, the API module 146 provides an application programming interface (API) 146 for the electronic signature service 140, with which third party applications 120 may call to receive various services, such as interactive services, provided by the electronic signature service 140.

The determining module 148, in some example embodiments, reviews and/or extracts information received via an API provided by the API module 146, and identifies and/or determines a location or point of entry in which the third party application is requesting to enter an interactive service provided by the electronic signature service 140. For example, the determining module 148 may identify within a received API call a request to enter the workflow at the e-signature stage of the interactive service, among other things.

Once the workflow point of entry is identified and/or determined based on information provided in an API call, a services module 149, in some example embodiments, provides the interactive service to the third party application 120 at the requested point of entry or stage. For example, the services module 149 may transmit a URL to the third party application 120 that, when followed by the third party application 120, provides the e-signature stage of the interactive service.

As illustrated in FIG. 1, the third party application 120 may include modules that enable the third party application to call or otherwise request an electronic signature service 140 to provide an interactive service, such as at a specific stage within a workflow of the interactive service, including a request module 122, an API call module 124, and a transmission module 126, among other things.

In some example embodiments, the request module 122 receives a request from a user of the third party application 120, such as from a signature requestor. The received request may be a request to edit or otherwise modify a document using an interactive electronic signature service, a request to facilitate obtaining a, e-signature from another party, and so on. For example, a document management application, such as an application that facilitates the creating and editing of documents, may receive input from a user selecting a section of a document at which the user would like to place a signature field.

Once a request is received, in some example embodiments, the API call module 124 generates one or inure API calls to transmit to the electronic signature service 140. The API call module may insert various different types of information into or associated with a generated API call, such as recipient information, callback URLs (e.g., URLs that receive callbacks during events in an agreement), document information (e.g., files), expiration information, security information e.g., (pin protection, knowledge base authentication, and so on), information associated with a received request, information associated with requested workflow stages provided by the electronic signature service, and so on. Once generated, the transmission module 126 transmits the API call and any associated information to an API provided by the third party application 140.

### Using API Calls to Utilize Aspects of an Electronic Signature Service

As described herein, in some example embodiments, an electronic signature service 140 provides interactive services at specific points of entry, or stages, to a third party application, based on information contained in an API call received from the third party application.

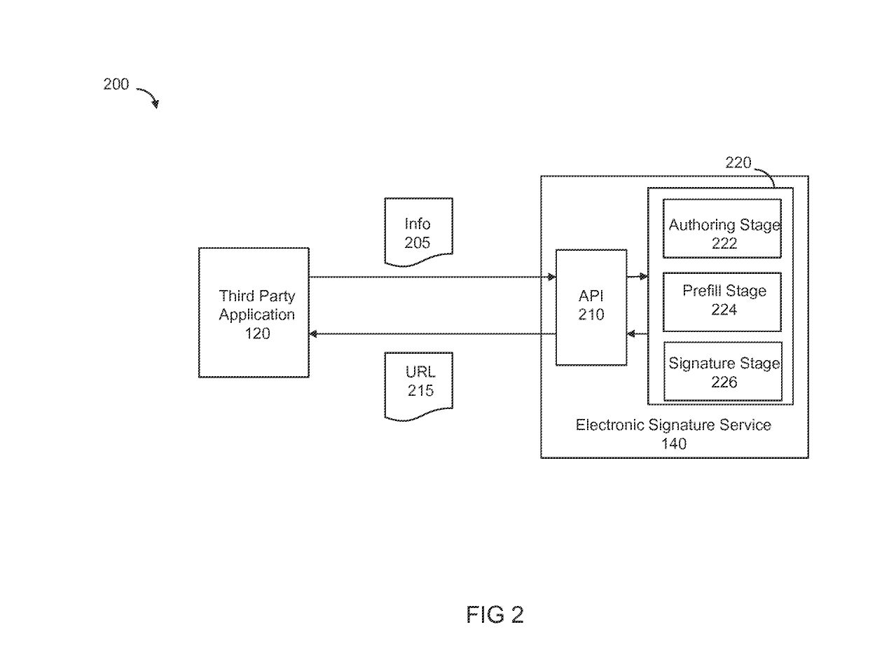

FIG. 2 is a block diagram illustrating an example of how an electronic signature service 140, consistent with some embodiments of the technology, provides one or more aspects of the service to a third party application. A third party application 120, such as document management application, transmits an API call 205 to the electronic signature service 140. The transmitted API call 205 includes different types of information, including information identifying a sender of a document, recipients of the document, files to be sent, how the documents should be signed, document status information, and/or information that identifies a stage or point of entry in which the third party application 120 is to enter an interactive workflow provided by the electronic signature service 140.

The electronic signature service 140 receives the API call 205, identifies a requested stage 220 from information within the API call 205, and selects one or more stages (e.g., an authoring stage 222, a prefill stage 224, a signature stage 226, and so on), to provide to the third party application 120. The electronic signature service 140 transmits information associated with a URL to the selected stage 220 to the third party application 120, enabling the third party application 120 to access the service at the requested stage via the URL.

Thus, in some example embodiments, the electronic signature service 140 may, in response to information within received API calls, provide the service at specific points of entry to third party applications. For example, a document author or signature requester may mark up a document using a third party application to indicate where a signature is to be placed, in which case the entry point to the workflow may be after this stage. As another example, a document may be marked up using the electronic signature service 140, leading to an API call to the service that requests an entry point to the workflow that provides functionality to mark up the document using the service,

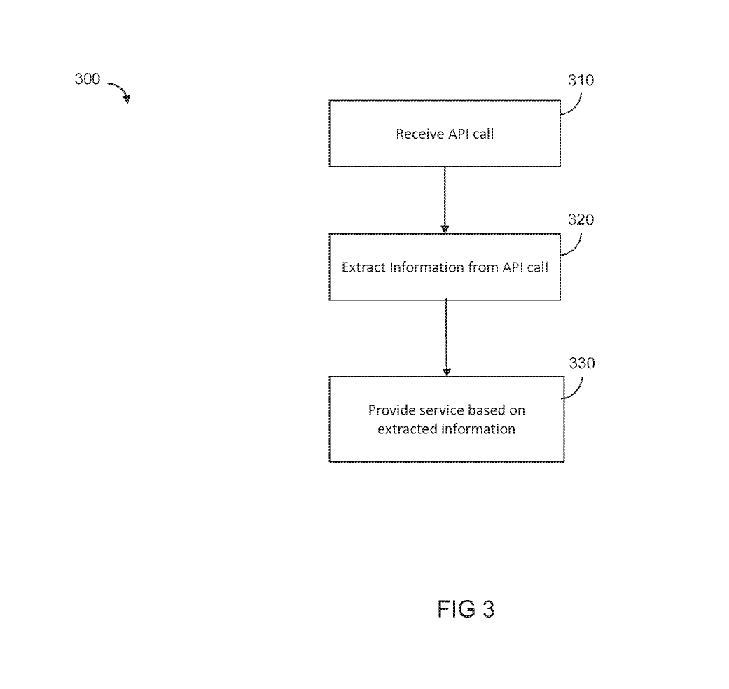

FIG. 3 is a flow diagram illustrating example method 300 for providing a requested stage of an electronic signature service to a third party application, consistent with some embodiments. In step 310, the electronic signature service receives an API call from a third party application. For example, in some example embodiments, the API module 146 of the electronic signature service 140 provides an API for the service, and receives an API call from a third party application 120.

In step 320, the electronic signature service extracts information from the API call. For example, in some example embodiments, the determining module 148 of the electronic signature service 140 identifies, determines, and/or extracts information provided by the API call, in order to select a workflow stage provided by the electronic signature service to provide to the requesting application. The determining module 148 may review various types of information associated with the received API call, including API key information, sender information, document creation information, requested stage information, status information associated document, and so on. For example, the determining module 148 may identify a status of a document currently being edited within the document management application via information contained by the API call, among other things.

In step 330, the electronic signature service provides the service based on the extracted information. For example, in some example embodiments, the services module 149 of the electronic signature service 140 transmits one or results to a requesting third party application 120, such as a standalone URL, a javascript snippet to an embedded page, and so on.

In some example embodiments, the electronic signature service 140 may provide the third party application 120 with a URL or other information allowing the application 120 to enter an interactive service workflow at an initial, or beginning stage, at a stage that skips at least the first stage of the workflow, at a final stage, or at any intermediate stage in between the first and final stage of the workflow. Also, the electronic signature service may, in response to certain information within an API call, provide two or more sequential or non-sequential stages of a requested workflow to a requesting application.

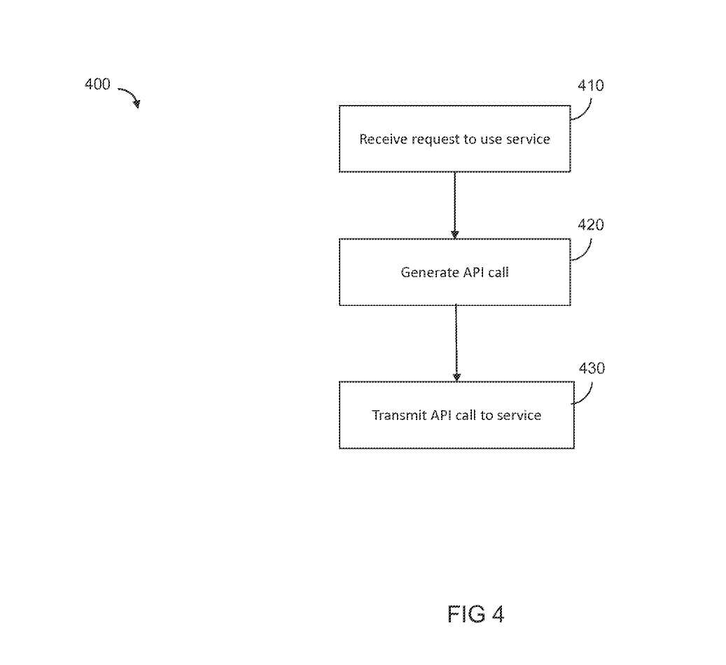

As described herein, a third party application 120, such as a document management application, may generate API calls that facilitate entering the workflow at a desired or requested stage, among other benefits. FIG. 4 is a flow diagram illustrating an example method 400 for a third party application to request a specific aspect of an electronic signature service using an API call, consistent with some embodiments.

In step 410, the third party application receives a request to access an interactive service provided by an electronic signature service. For example, in some example, embodiments, the request module 122 of the third party application 120 receives input from a user, such as input selecting an area of document in which to place a signature field in the document.

In step 420, the third party application generates an API call based on the received request. For example, in some example embodiments, the API call module 124 generates an API call that includes information associated with a specific workflow stage of an interactive service provided by the electronic signature service 140, such as the workflow stage that facilitates placement of a signature field at a specific location within a document.

As described herein, the generated API call may include various types of information, including information identifying the application sending the API call and information identifying a specific aspect of the electronic signature service in which to provide to the third party application, among other things.

in step 430, the third party application transmits the API call to the API of the electronic signature service. For example, in some example embodiments, the transmission component 126 of the third party application 120 transmits the API call to the electronic signature service 140.

### CONCLUSION

Some example embodiments of the technology, therefore, may provide a third party application with access to an electronic signature service based on API calls to that service, in some examples, the technology facilitates access to the electronic signature service at specific workflow stages, enabling a user of a third party application to receive the specific service currently desired when creating or editing a document to be electronically signed by other parties, among other benefits.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein my be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

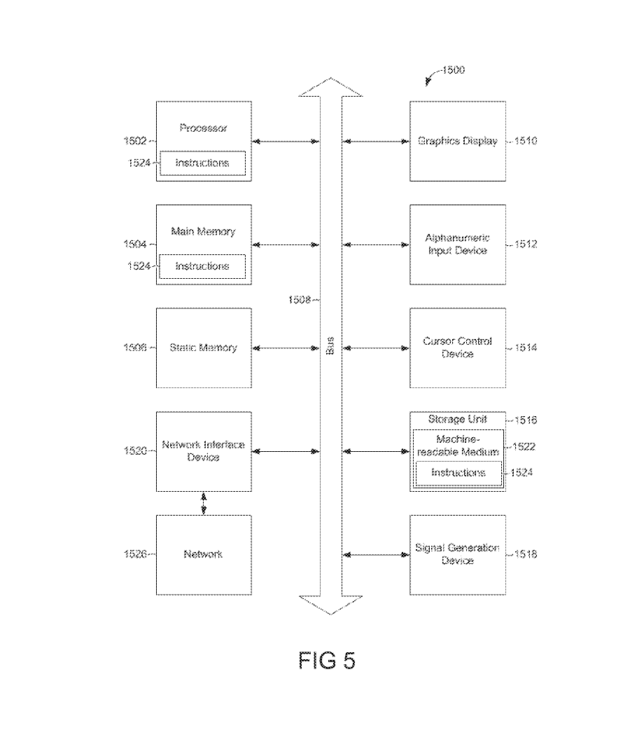

FIG. 5 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media

While the machine-readable medium 1522 is illustrated an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® nd WiMax® networks). The term “transmission medium” shall be taken to include any intangible medium that is capable of storing, encoding or carrying instructions for execution by the machine, and includes digital or analog communications signals or other intangible medium to facilitate communication such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method performed by an electronic signature service, the method comprising:
receiving, from a third party document management application, an application programming interface (API) call via an application programming interface provided by the electronic signature service;
extracting information from the received API call requesting a specific workflow stage provided by the electronic signature service; and
providing the electronic signature service at the specific workflow stage to the third party document management application based on the extracted information.

2. The method of claim 1, wherein the extracted information includes information identifying the specific workflow stage of the electronic signature service.

3. The method of claim 1, wherein the extracted information includes information identifying an electronic signature stage of the electronic signature service.

4. The method of claim 1, wherein the extracted information includes information identifying a subset of two or more workflow stages of the electronic signature service.

5. The method of claim 1, wherein providing the electronic signature service at the specific workflow stage includes providing a workflow stage associated with implementing a signature field into a document currently being edited by the third party document management application.

6. The method of claim 1, wherein providing the electronic signature service at the specific workflow stage includes providing a URL associated with the specific workflow stage.

7. The method of claim 1, wherein providing the electronic signature service at the specific workflow stage includes providing a JavaScript snippet associated with the specific workflow stage.

8. A system supported by a document management application for requesting use of an electronic signature service, the system comprising:
a request module, wherein the request module is configured to receive a request from a user of the document management application to utilize the electronic signature service when editing a document aria the document management application;
an API generation module, wherein the API generation module is configured to generate an API call that includes information associated with the received request; and
a transmission module, wherein the transmission module is configured to transmit the generated API call to an application programming interface of the electronic signature service.

9. The system of claim 8, wherein the request module is configured to receive a request from the user to utilize the electronic signature service at an intermediate point of entry of the electronic signature service; and wherein the API generation module is configured to generate an API call that includes information associated identifying the intermediate of entry of the electronic signature service.

10. The system of claim 8, wherein the request module is configured to receive a request from the user to utilize the electronic signature service at a signature stage of the electronic signature service; and wherein the API generation module is configured to generate an API call that includes information associated identifying the signature stage of the electronic signature service.

11. A tangible computer-readable medium whose contents, when executed by a computing system, cause the computing system to perform a method at an electronic signature service, the method comprising:
receiving an application programming interface (API) call at an API provided by the electronic signature service; and
in response to the received call, providing the electronic signature service to a document management application in communication with the electronic signature service.

12. The computer-readable medium of claim 11, wherein the API call includes information identifying the document management application and information identifying a portion of the electronic signature service in which to provide to the document management application.

13. The computer-readable medium of claim 11, further comprising:
identifying a status of a document currently being edited within the document management application;
wherein providing the electronic signature service to a document management application includes providing the electronic signature service at a workflow stage that is associated with the identified status of the document currently being edited within the document management application.

14. The computer-readable medium of claim 11, further comprising:
identifying a status of a document currently being edited within the document management application via information contained by the API call;
wherein providing the electronic signature service to a document management application includes providing the electronic signature service at a workflow stage that is associated with the identified status of the document currently being edited within the document management application.

15. The computer-readable medium of claim 11, further comprising:
identifying a status of a document currently being edited within the document management application via information contained by a subsequently received API call;
wherein providing the electronic signature service to a document management application includes providing the electronic signature service at a workflow stage that is associated with the identified status of the document currently being edited within the document management application.

16. The computer-readable medium of claim 15, wherein providing the electronic signature service to a document management application in communication with the electronic signature service includes providing a URL associated with an intermediate workflow stage of the electronic signature service.
